(19) United States
(12) Patent Application Publication
(10) Pub. No.: US 2010/0054519 A1
(43) Pub. Date: Mar. 4, 2010

(54) Audio Communication System

(76) Inventors: James P. Mulvey, Reading, MA (US); William M. Rabinowitz, Bedford, MA (US); John Trotter, Sudbury, MA (US)

Correspondence Address: Bose Corporation;c/o Donna Griffiths, The Mountain, MS 40, IP Legal - Patent Support, Framingham, MA, 01701, US

(21) Appl. No.: 12/203,157

(22) Filed: Sep. 3, 2008

(51) Int. Cl. H04R 1/02

(52) U.S. Cl. 381/386

(57) ABSTRACT

An audio producing device includes a receiver for wirelessly receiving a digital audio signal from an audio source device. The audio source device may transmit the digital audio signal at a variable bitrate. A logic device determines whether the bitrate at which the audio signal is received is below a predetermined threshold. A first indicator provides an indication to a user of the system when the bitrate is below the threshold. An electro-acoustic transducer utilizes information in the digital audio signal to produce audio out loud.

### FIELD

This disclosure is in the field of wireless audio and more specifically relates to an audio producing apparatus.

### BACKGROUND

Bluetooth devices may stream audio data over a wireless link from a source device (SRC) to a sink device (SNK) using the Advanced Audio Distribution Profile (A2DP) defined by the Bluetooth standard. The definition for A2DP allows the use of a sub-band codec (SBC) compression scheme to encode audio information before it is transmitted over the wireless link. The SBC can use one of several bitrates that are specified in the A2DP definition. The audio quality available using SBC ranges from high quality, where any audio artifacts are almost imperceptible, to bitrates where the audio artifacts are blatant.

A SRC device (which may be a phone that stores MP3 music files) chooses the bitrate to encode an audio stream sent across the wireless link. The SNK (which may be a high fidelity A2DP stereo speaker system) must decode the audio at the same bitrate chosen by the SRC, even if the bitrate is too low to support a high fidelity sound quality. If the bitrate is too low the result is audio reproduction at the SNK that contains many audio distortions and artifacts not present in the original audio source contained on the SRC.

A user of the system may not understand that audio quality can be greatly impacted by the A2DP process, and by the choice that the SRC device makes when choosing the bitrate. Furthermore, the user may not realize the A2DP process can vary the audio quality over time in response to certain environmental changes. For example, A SRC may initiate transmission at a high bitrate but then change to a lower bitrate if interference occurs (e.g., from a microwave oven). The user may not know why the audio sounds poor, and so is unable to ensure a consistently high quality audio experience with a SNK device. Additionally, the user may think that poor audio quality is caused by the speaker system itself rather than a low bitrate A2DP wireless connection. As a result, the reputation of that brand of speaker system may be tarnished.

### SUMMARY

In one aspect, an audio producing device includes a receiver for wirelessly receiving a digital audio signal from an audio source device. The audio source device may transmit the digital audio signal at a variable bitrate. A logic device determines whether the bitrate at which the audio signal is received is below a predetermined threshold. A first indicator provides an indication to a user of the system when the bitrate is below the threshold. An electro-acoustic transducer utilizes information in the digital audio signal to produce audio out loud.

Embodiments may include one or more of the following features. The receiver is an A2DP compliant receiver. The audio source device is a cellular telephone. The first indicator provides a visual indication to the user. The system further includes a second indicator which provides an indication of a wireless connection status between the receiver and the audio source device. The second indicator provides a visual indication to the user. The second indicator is able to reflect that (a) the receiver is discoverable to the audio source device, (b) the receiver and the audio source device are connecting with each other, and (c) the receiver and the audio source device are connected to each other. The first indicator provides a different indication to the user when the bitrate is above the threshold.

In another aspect, a method of indicating a quality of a wireless connection includes the steps of wirelessly receiving a digital audio signal from an audio source device and determining whether a bitrate at which the audio signal is received is on one side or the other side of a threshold. An indication is provided to a user of the audio source device when the bitrate is on one side of the threshold. A different indication is provided to the user when the bitrate is on the other side of the threshold.

Embodiments may include one or more of the following features. Information in the digital audio signal is utilized to operate an electro-acoustic transducer to produce audio out loud. The receiver is an A2DP compliant receiver. The audio source device is a cellular telephone. The first indicator provides a visual indication to the user.

In another aspect, a wireless receiver includes a receiver for wirelessly receiving a digital audio signal from an audio source device that sets a bitrate at which the audio signal is transmitted from the audio source device. A first indicator provides a first indication to a user of the receiver. The first indication is dependent on a bitrate that is received by the receiver.

Embodiments may include one or more of the following features. A second indicator provides an indication of a wireless connection status between the receiver and the audio source device. The second indicator provides a visual indication to the user. The second indicator is able to reflect that (a) the receiver is discoverable to the audio source device, (b) the receiver and the audio source device are connecting with each other, and (c) the receiver and the audio source device are connected to each other. The audio source device sets a bitrate at which the audio signal is transmitted from the audio source device. The characteristic is when the bitrate is below a preset first threshold. The first indicator provides a different indication to the user when the bitrate is above the threshold. The wireless receiver is removably insertable into an audio producing system. The receiver further includes a manually operable actuator that when actuated enables the wireless receiver to be removed from the audio producing system. The audio source device may transmit the digital audio signal at a variable bitrate. The wireless receiver can be replaced in the audio producing system with a dock that is able to electrically connect to an audio source device. The receiver includes a manually operable actuator that when actuated causes the receiver to attempt to connect with the audio source device. The receiver further includes a logic device for determining whether a bitrate at which the audio signal is received is below the threshold. The receiver further includes a second preset threshold different from the first threshold. A second indication is provided to the user when the bitrate is between the first and second thresholds. A third indication is provided to the user when the bitrate is above the second threshold.

### BRIEF DESCRIPTION OF THE DRAWINGS

FIG. 1 is perspective view of an audio producing system;

FIG. 2 is a partial perspective view of the system of FIG. 1 with an insert removed; and

FIG. 3 is a partial perspective view of the system of FIG. 1 with a wireless receiver inserted into the system, and a cellular telephone.

### DETAILED DESCRIPTION

A wireless audio playback device, such as a wireless powered speaker device or wireless headphone device, may provide a user a clear indication of the status of the wireless connection as well as the quality of the received audio signal. The bitrate of data received by the wireless audio playback device can be a good predictor of the level of audio quality, and the device can use the received bitrate to present a clear indication of the quality of the received signal. By clearly displaying this information, a user can better understand the operating conditions of the system and take steps to correct a poor wireless connection (e.g., by moving the wireless source device closer to the wireless audio playback device and/or away from an interfering device).

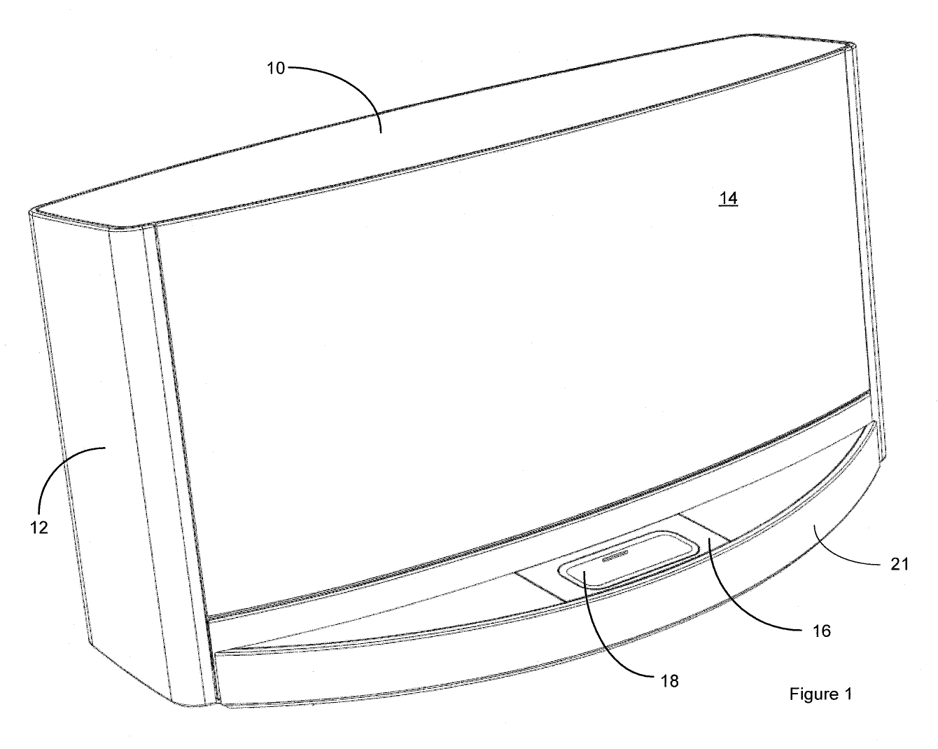

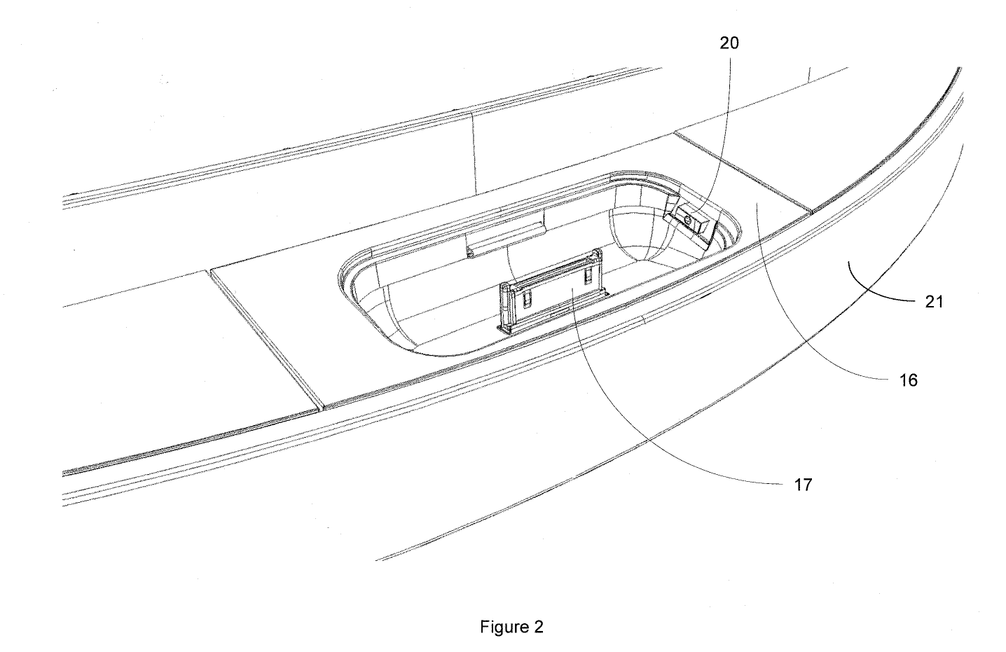

For example, as shown in FIGS. 1 and 2, an audio producing system 10 includes a housing 12 and a substantially acoustically transparent speaker grill 14. Behind the grill 14 are two speakers (not shown) that each include an electro-acoustic transducer which moves a diaphragm to create acoustic waves. A dock 16 includes a connector 17 (FIG. 2) and so is able to electrically connect with a portable audio source device such as an iPod® portable media player available from Apple Computer of Cupertino, Calif. The dock 16 includes a removable insert 18 that is similar to an insert used in the SoundDock® Portable digital music systems available from the Bose Corp. of Framingham, Mass. The insert 18 is held in the dock by an interference fit. Various inserts are used in the dock 18 to accommodate the various types of iPod® portable media players available on the market. The dock 16 is removable from the system 10 by first removing the insert 18 from the dock 16. FIG. 2 shows the dock 16 with the insert 18 removed. With the insert 18 removed, a user is able to press a button 20 (a manually operable actuator) which release a catch (not shown) and allows the dock 16 to be removed from the system 10. When the dock 16 is removed, an opening (not shown) in a front tray 21 of the device is exposed.

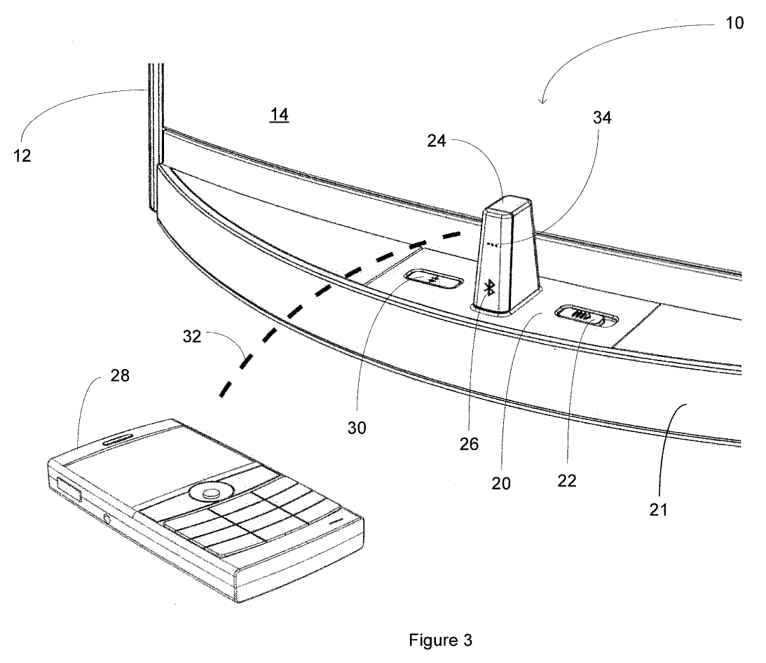

Turning to FIG. 3, the system 10 is shown in which the dock 16 (shown in FIG. 1) has been replaced by a Bluetooth A2DP compliant wireless receiver 20 that is capable of receiving a digital audio signal from an audio source device. A manually operable actuator such as spring-loaded slider 22 can be actuated by a user of the system by moving the slider to the right to release a catch (not shown) permitting the receiver 20 to be removed from the system 10. The receiver 20 can then be re-inserted back into the system 10 when desired by plugging the receiver into the opening of the front tray 21. Thus, the receiver 20 is removably insertable into the system 10. The receiver 20 includes a portion 24 within which is located an antennae (not shown). The receiver 20 also includes a logic device (not shown) that controls the operation of the receiver 20 as described below.

The system 10 is powered by, for example, 110 volt mains AC. One example of the system 10 operates as follows. When the system 10 is powered on and the receiver 20 is being used for the first time (i.e. it has never been paired with any audio source device), the receiver 20 switches to a discoverable mode for 30 minutes in which it attempts to pair with a Bluetooth audio source device. If the receiver 20 does not pair with any such device in 30 minutes, the system 10 goes into a low-power standby state in which it the receiver 20 is not discoverable. The receiver can be brought out of the low power state and become discoverable again by pressing a button 30 on the receiver 20. When the receiver 20 is in the discoverable mode, a visual indicator in the form of an icon 26 is illuminated by a light emitting diode (LED) that oscillates smoothly over a 4 second period from 0-75% power. The icon 26 provides an indication of a wireless connection status between the receiver 20 and an audio source device. When the receiver 20 is in the discoverable mode, other Bluetooth enabled audio source devices, such as cellular telephone (cell phone) 28, are able to discover the receiver 20 as a Bluetooth A2DP/AVRCP device. A string that represents receiver 20 in the found device list of the cell phone 28 is, for example, “Bose SoundDock” Device. Upon receiving this message, the user of the Bluetooth audio source device can command the device to pair with receiver 20. Another example of an audio source device is a USB Bluetooth dongle (e.g., an A2DP SRC device dongle) that is connected to a computer. The dongle can wirelessly stream digital audio data from the computer to the receiver 20.

If a user would like to pair to the cell phone 28 with system 10 and the receiver 20 has been previously used, the receiver 20 will enter the discoverable mode after a long press (e.g., 3 or more seconds) of the button 30 (a manually operable actuator). Actuating the button 30 causes the receiver 20 to attempt to connect with the cell phone 28. After the cell phone 28 finds receiver 20 and initiates pairing, the receiver 10 allows the cell phone 28 to bypass a security PIN confirmation and complete the connection. However, some audio source devices (e.g., cell phones) may require the user to input a security PIN code in order for the audio source device to fully connect with the receiver 20. In this case, the user enters a code into the audio source device (e.g., inputting the number 0 four times) that corresponds with the receiver 20 in order to complete the connection. When the cell phone 28 is paired with receiver 20 and has initiated a connection request, the receiver 20 automatically initiates connection to the cell phone 28. When receiver 20 is connecting with the cell phone 28, the visual indicator 26 flashes at a fast rate (e.g., turn on for 350 msec, turn off for 350 msec, turn on for 350 msec, etc.). A dashed line 32 represents the wireless connection between the receiver 20 and the cell phone 28.

Once the receiver 20 and the cell phone 28 are successfully connected to each other, the visual indicator 26 remains steadily illuminated. In this example the receiver 20 is preferably not simultaneously discoverable while it is connected to another device such as cell phone 28. However, any long press (e.g., for 3 or more seconds) on the button 30 will transition the receiver to the discoverable mode. The receiver 20 can preferably only be connected to one Bluetooth device (e.g., cell phone 28) at a time. In one implementation, the logic device in receiver 20 can remember the six most recently connected Bluetooth devices for automatic reconnection purposes.

When the system 10 is in a low-power standby mode, a short press of the button 30 causes the receiver 20 to attempt to connect to the last connected Bluetooth device (e.g., cell phone 28). If this connection fails or times out after 20 seconds, the receiver 20 attempts to connect sequentially with up to five other devices (up to 20 seconds per device) that have been previously connected and saved in memory of the logic device of receiver 20 (ordered in priority by most recent connection). If a connection still cannot be established after trying all stored devices, the receiver 20 remains on and discoverable for up to 30 minutes (as discussed above).

After a connection is established, the system 10 mutes itself when the data packet loss has reached a certain level (e.g., because the cell phone 28 has moved out of range or because of interference) and automatically attempts to reconnect to the cell phone 28. If the reconnection does not succeed after some predetermined amount of time (e.g., 5 minutes), or the system 10 does not receive a valid command during that time, the system 10 returns to a low-power standby state. When an established Bluetooth connection is ended by the cell phone 28, the system 10 will remain on without attempting to reconnect. If no new valid command is received after 30 minutes, the system 10 returns to its low-power standby state. The visual indicator 26 is turned off upon disconnection. Turning off the system 10 disconnects the receiver 20 with the cell phone 28. When the system 10 is on and connected to the cell phone 28, a long press (e.g., 3 or more seconds) on the button 30 disconnects the receiver 20 from the cell phone 28 and reverts the receiver 20 into the discoverable mode.

Once the cell phone 28 and receiver 20 are connected, the cell phone 28 is able to transmit digital audio data (e.g., music) to the receiver 20. The information in the digital audio signal is utilized to drive the electro-acoustic transducers in the system 10 to produce audio output to, for example, speakers (for playing audio out loud) or to headphones/earbuds. The cell phone 28 (or other Bluetooth device connected to system 10) determines the bitrate at which the audio data is transmitted to the receiver. Different Bluetooth devices (e.g., cell phone 28) use various factors in determining which bitrate to use. These factors include, but are not limited to, the availability of CPU resources on the phone for SBC encoding, the default bitrate the cell phone's designer chose to use, wireless signal strength (the stronger the signal the higher the bitrate), wireless interference (the greater the interference the lower the bitrate), and power consumption (the lower the cell phone's battery the lower the bitrate). Generally speaking, the higher the bitrate the better the audio quality. Most Bluetooth devices currently use the sub-band codec (SBC) to encode the audio data. Under the current Bluetooth standard for SBCs the minimum bitrate to be transmitted is 47 Kbits/second which provides poor audio quality. The upper limit of the Bluetooth specification for SBC is 1.4 Mbits/second. Bluetooth devices that transmit high quality audio typically transmit the audio data at about 320 Kbits/second or above. Other codecs such as an MP3 codec can be used instead of SBC.

In the illustrated implementation, the logic device in the receiver 20 uses a predetermined SBC bitpool threshold to distinguish higher quality audio data from lower quality audio data. This bitpool threshold is set at, for example, 44. The bitpool is used by the cell phone along with one or more other parameters to set the bitrate for transmission of audio data. The bitpool is directly related to the bitrate. The use of a different codec such as an MP3 codec instead of SBC may cause a different threshold to be used such as a bitrate threshold instead of a bitpool threshold. The logic device determines whether the bitrate at which audio data is received is above or below the bitpool threshold. When audio data is transmitted by the cell phone 28 to the receiver 20 at a data rate that is determined to be less than this threshold, the logic device causes a visual indicator 34, which includes an LED, to be illuminated in a steady manner, thus providing an indication to the user of poorer audio quality. The illuminated visual indicator 34 tells the user that the current bitrate will provide a lower quality audio performance, thus enabling the user to try to correct the situation. Corrective action can include moving the cell phone 28 closer to the receiver 20, moving the system 10 away from sources of interference (e.g., a microwave oven), and resetting the audio data transmission bitrate on the cell phone 28 to a higher level. If the indicator 34 is lit due to a temporary factor (e.g., microwave in use or cell phone 28 goes out of range) and acceptable audio quality (above the threshold) is recovered later, the indicator 34 is turned off when the better audio is resumed.

When the digital audio data is transmitted at a data rate that is determined to be above the bitpool threshold, the indicator 34 is extinguished (or not turned on in the first place), thus providing a different visual indication to the user that higher audio quality has been obtained. When the Bluetooth link is disconnected, the visual indicator 34 is turned off.

Although a single threshold has been described above, two or more thresholds can be used to distinguish multiple levels of audio quality. In this case indicator 34 can be operated in different modes (e.g., slowly oscillating, quickly flashing, steadily illuminated) as was described above for indicator 26 in order to indicate the various levels of audio quality. Alternatively, the indicator 34 can be replaced by two or more visual indicators to indicate the various levels of audio quality. Although the indicators 26 and 34 are visual indicators, one or both of these visual indicators can be replaced by another type of indicator such as an audio indicator. If an audio indicator is used, various sounds can be produced to identify to the user the different connection states (e.g., discoverable, connecting, connected) and/or the different audio qualities. In some implementations, the system may include a visual indicator that does not use predetermined thresholds to classify bitrates, but rather simply displays the received bitrate (e.g., on an LED panel).

A number of implementations have been described. Nevertheless, it will be understood that additional modifications may be made without departing from the spirit and scope of the inventive concepts described herein, and, accordingly, other embodiments are within the scope of the following claims.

What is claimed is:

1. An audio producing device, comprising:
a receiver for wirelessly receiving a digital audio signal from an audio source device, wherein the audio source device may transmit the digital audio signal at a variable bitrate;
a logic for determining whether the bitrate at which the audio signal is received is below a predetermined threshold;
a first indicator for providing an indication to a user of the system when the bitrate is below the threshold; and
an electro-acoustic transducer that utilizes information in the digital audio signal to produce audio out loud.

2. The device of claim 1, wherein the receiver is an A2DP compliant receiver.

3. The device of claim 1, wherein the audio source device is a cellular telephone.

4. The device of claim 1, wherein the first indicator provides a visual indication to the user.

5. The device of claim 1, further including a second indicator which provides an indication of a wireless connection status between the receiver and the audio source device.

6. The device of claim 5, wherein the second indicator provides a visual indication to the user.

7. The device of claim 5, wherein the second indicator is able to reflect that (a) the receiver is discoverable to the audio source device, (b) the receiver and the audio source device are connecting with each other, and (c) the receiver and the audio source device are connected to each other.

8. The device of claim 1, wherein the first indicator provides a different indication to the user when the bitrate is above the threshold.

9. A method of indicating a quality of a wireless connection, comprising the steps of:
wirelessly receiving a digital audio signal from an audio source device;
determining whether a bitrate at which the audio signal is received is on one side or the other side of a threshold; and
providing one indication to a user of the audio source device when the bitrate is on one side of the threshold, and providing a different indication to the user when the bitrate is on the other side of the threshold.

10. The method of claim 9, further including the step of; utilizing information in the digital audio signal to operate an electro-acoustic transducer to produce audio out loud.

11. The method of claim 9, wherein the receiver is an A2DP compliant receiver.

12. The method of claim 9, wherein the audio source device is a cellular telephone.

13. The method of claim 9, wherein the first indicator provides a visual indication to the user.

14. A wireless receiver, comprising:
a receiver for wirelessly receiving a digital audio signal from an audio source device that sets a bitrate at which the audio signal is transmitted from the audio source device; and
a first indicator for providing a first indication to a user of the receiver, the first indication being dependent on a bitrate that is received by the receiver.

15. The receiver of claim 14, further including a second indicator which provides an indication of a wireless connection status between the receiver and the audio source device.

16. The receiver of claim 15, wherein the second indicator provides a visual indication to the user.

17. The receiver of claim 15, wherein the second indicator is able to reflect that (a) the receiver is discoverable to the audio source device, (b) the receiver and the audio source device are connecting with each other, and (c) the receiver and the audio source device are connected to each other.

18. The receiver of claim 14 wherein the audio source device sets a bitrate at which the audio signal is transmitted from the audio source device.

19. The receiver of claim 18 wherein the characteristic is when the bitrate is below a preset first threshold.

20. The receiver of claim 19 wherein the first indicator provides a different indication to the user when the bitrate is above the threshold.

21. The receiver of claim 14, wherein the wireless receiver is removably insertable into an audio producing system.

22. The receiver of claim 21, further including a manually operable actuator that when actuated enables the wireless receiver to be removed from the audio producing system.

23. The receiver of claim 21, wherein the audio source device may transmit the digital audio signal at a variable bitrate, wherein the wireless receiver can be replaced in the audio producing system with a dock that is able to electrically connect to an audio source device.

24. The receiver of claim 14, further including a manually operable actuator that when actuated causes the receiver to attempt to connect with the audio source device.

25. The receiver of claim 19, further including a logic device for determining whether a bitrate at which the audio signal is received is below the threshold.

26. The receiver of claim 19, further including a second preset threshold different from the first threshold, a second indication being provided to the user when the bitrate is between the first and second thresholds, a third indication being provided to the user when the bitrate is above the second threshold.

27. The receiver of claim 1, wherein the threshold is a bitpool threshold.

28. The receiver of claim 1, further including a second indicator for visually indicating a bitrate at which the digital audio signal is received by the receiver.
